(19) United States
(12) Patent Application Publication
(10) Pub. No.: US 2012/0098998 A1
(43) Pub. Date: Apr. 26, 2012

(54) METHOD FOR COMBINING FILES AND MOBILE DEVICE ADAPTED THERETO

(75) Inventor: Sung Chull LEE, Suwon-si (KR)

(73) Assignee: SAMSUNG ELECTRONICS CO. LTD., Suwon-si (KR)

(21) Appl. No.: 13/272,575

(22) Filed: Oct. 13, 2011

(30) Foreign Application Priority Data
Oct. 20, 2010 (KR) 10-2010-0102262

(51) Int. Cl. H04N 5/76

(52) U.S. Cl. 348/231.4; 348/E05.024

(57) ABSTRACT

A method and a mobile device for providing a file synthesis function are provided. The mobile device includes an audio processing unit for outputting audio signals when an audio file is reproduced, a camera for acquiring at least one video during the audio file reproduction, and a controller for enabling the camera to acquire the at least one video during the audio file reproduction and for including the acquired at least one video in the currently reproduced audio file.

### PRIORITY

This application claims the benefit under 35 U.S.C. §119(a) of a Korean patent application filed on Oct. 20, 2010 in the Korean Intellectual Property Office and assigned Serial No. 10-2010-0102262, the entire disclosure of which is hereby incorporated by reference.

### BACKGROUND OF THE INVENTION

1. Field of the Invention

This invention relates to mobile devices. More particularly, the invention relates to a method that can combine a video acquired via a camera with an audio file, so that the video serves as an album art image or a representative image of the audio file.

2. Description of the Related Art

Mobile devices are widely used because they can be easily carried and provide a variety of functions. In order to provide various functions, mobile devices typically include corresponding modules, for example, a music player module for playing back audio files, a camera module for taking videos, etc. Camera modules are now a typical feature of mobile devices.

Mobile devices with camera modules support a preview function for displaying videos, acquired via the camera modules, on the display units, and a function for storing acquired video according to the user's request. Mobile devices with music player modules may reproduce audio files and output audio signals via the audio processing unit.

In recent years, mobile devices have supported a multi-play function that can simultaneously perform various functions. Mobile devices with a multi-play function support a combined function so that the mobile devices allow users to browse web pages or write a message, while playing back an audio file. Accordingly, there is a need for services to create requested data based on various types of user functions.

### SUMMARY OF THE INVENTION

Aspects of the invention are to address at least the above-mentioned problems and/or disadvantages and to provide at least the advantages described below. Accordingly, an aspect of the present invention is to provide a method that can combine a video acquired via a camera with a previously stored audio file, so that the video serves as an album art image or a representative image of the audio file. Aspects of the present invention further provide a mobile device adapted to the method.

In accordance with an aspect of the present invention, a method for providing a file combining function is provided. The method includes reproducing an audio file, enabling a camera during the audio file reproduction, acquiring at least one video via the camera during the audio file reproduction, and combining the acquired at least one video with the currently reproduced audio file.

In accordance with another aspect of the invention, a mobile device for providing a file combining function is provided. The device includes an audio processing unit for outputting audio signals when an audio file is reproduced, a camera for acquiring at least one video during the audio file reproduction, and a controller for enabling the camera to acquire the at least one video during the audio file reproduction and for including the acquired at least one video in the currently reproduced audio file.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a schematic block diagram of a mobile device according to an exemplary embodiment of the present invention;

FIG. 2 illustrates a detailed view of a controller of a mobile device according to an exemplary embodiment of the present invention;

FIG. 3 illustrates a flowchart that describes a method for combining files, according to an exemplary embodiment of the present invention;

FIG. 4 illustrates screens to describe a process of combining files, according to an exemplary embodiment of the present invention;

FIG. 5 illustrates a screen to describe a process of editing a video as a representative image or album art image, according to an exemplary embodiment of the present invention; and

FIG. 6 illustrates screens to describe a process of editing a video as a representative image or album art image, according to another exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention is provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

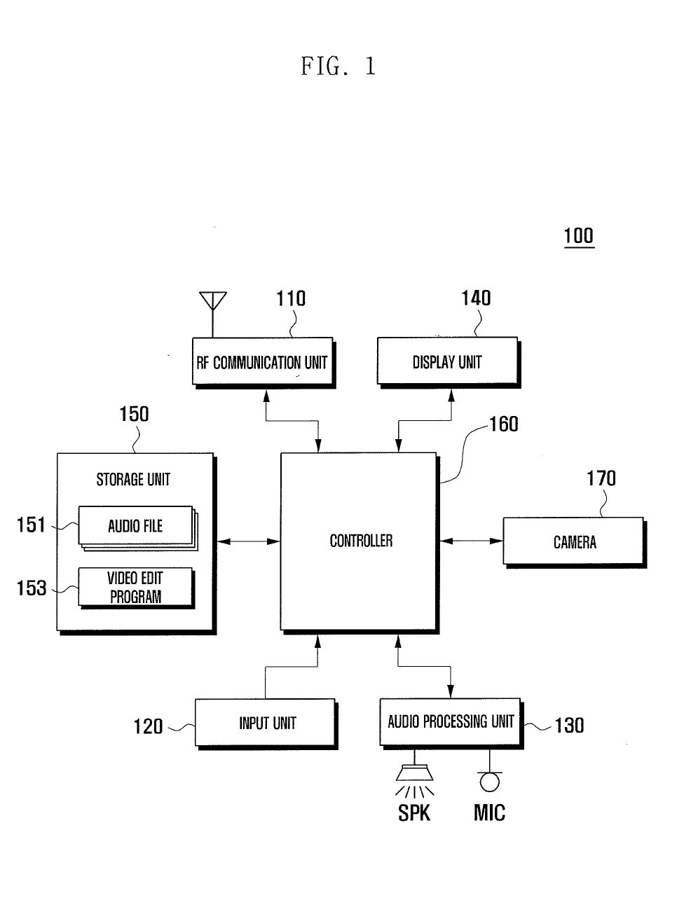

FIG. 1 illustrates a schematic block diagram of a mobile device according to an exemplary embodiment of the present invention.

Referring to FIG. 1, the mobile device 100 includes a Radio Frequency (RF) communication unit 110, an input unit 120, an audio processing unit 130, a display unit 140, a storage unit 150, a camera 170, and a controller 160. The mobile device 100 may include additional units not shown. Similarly, the functionality of two or more of the above units may be integrated into a single component.

The mobile device 100 may acquire a video of a subject via the camera 170, while playing back an audio file stored in the storage unit 150, for example, an audio file such as MP3 file. The mobile device 100 may also perform an automatic editing process by including an acquired video in the currently reproduced audio file, as a representative image or album art image. When the mobile device 100 reproduces the edited audio file, the mobile device 100 may output the video included in the audio file, as a representative image or album art image, so that the user can recall the feeling, situation, and/or environment the time when the user listened to the audio file. For example, if the user combined a scene photographed during the trip with an audio file, and then listens to the audio file after coming back from the trip, the user can easily recall the feeling and environment where the user saw the scenes during the trip. In addition, if the user takes a video of a person while listing to music and combines the video with the music file, the user can easily recall the impression or the memory of the person when listening to the music later. The configuration of the mobile device 100 is described below.

The RF communication unit 110 establishes a communication channel with a base station and performs data communication or voice call with the other mobile device via the channel. The RF communication unit 110 includes an RF transmitter for up-converting the frequency of signals to be transmitted and amplifying the signals, and an RF receiver for low-noise amplifying received RF signals and down-converting the frequency of the received RF signals. The RF communication unit 110 may transmit, to the other mobile device, an audio file 151 that includes a video, acquired via the camera 170, as a representative image or an album art image, according to whether the audio file has copyright protection. The user of the mobile device 100 can share the user's created audio file with the other mobile device users. The mobile device user can more properly transfer the user's feeling or atmosphere regarding an experience or memory to the other mobile device users. The RF communication unit 110 may be omitted if the mobile device 100 does not support a mobile communication function.

The input unit 120 includes input keys and function keys that allow a user to input numbers or letter information and to set a variety of functions. The function keys include direction keys, side keys, shortcut keys, etc., which may be set to perform specific functions. The input unit 120 creates key signals for controlling functions of the mobile device 100 and transfers them to the controller 160. The input unit 120 may create a variety of input signals according to the user's request, for example, for reproducing an audio file 151 stored in the storage unit 150, for activating the camera 170 during the reproduction of the audio file 151, for acquiring a video via the camera 170, and for determining whether to combine the acquired video with the audio file 151, as a representative image or album art image. The input unit 120 may also transfer a created input signal to the controller 160, so that the controller 160 can perform a file synthesis function.

The audio processing unit 130 outputs, to a speaker (SPK), audio signals received via the RF communication unit 110 or created when an audio file stored in the storage unit 150 is reproduced. The audio processing unit 130 also transfers audio signals received via a microphone (MIC), such as voice signals, to the RF communication unit 110. The audio processing unit 130 may output audio signals created when an audio file stored in the storage unit 150 is reproduced. The audio processing unit 130 may also output voice help related to the operations of the camera 170 via the speaker (SPK). The voice help may be muted while the user listens to an audio file.

The display unit 140 includes a display panel and a touch panel installed on the display panel. The display panel displays menu screens of the mobile device 100, user's input data, function setting information, information to be provided to the user, etc. The display unit 140 may perform a touch screen function via the touch panel. The touch panel creates input signals according to a user's touches. The display unit 140 may be implemented with a flat Thin Film Transistor (TFT)-based display device, such as a Liquid Crystal Display (LCD), an Organic Light Emitting Diode (OLED), etc. The display unit 140 may display an album art image or representative image of an audio file combined with a video. The display unit 140 may display a default album art image included in an audio file 151, and an album art image or representative image created by editing a video that is acquired via the camera 170, according to the control of the controller 160.

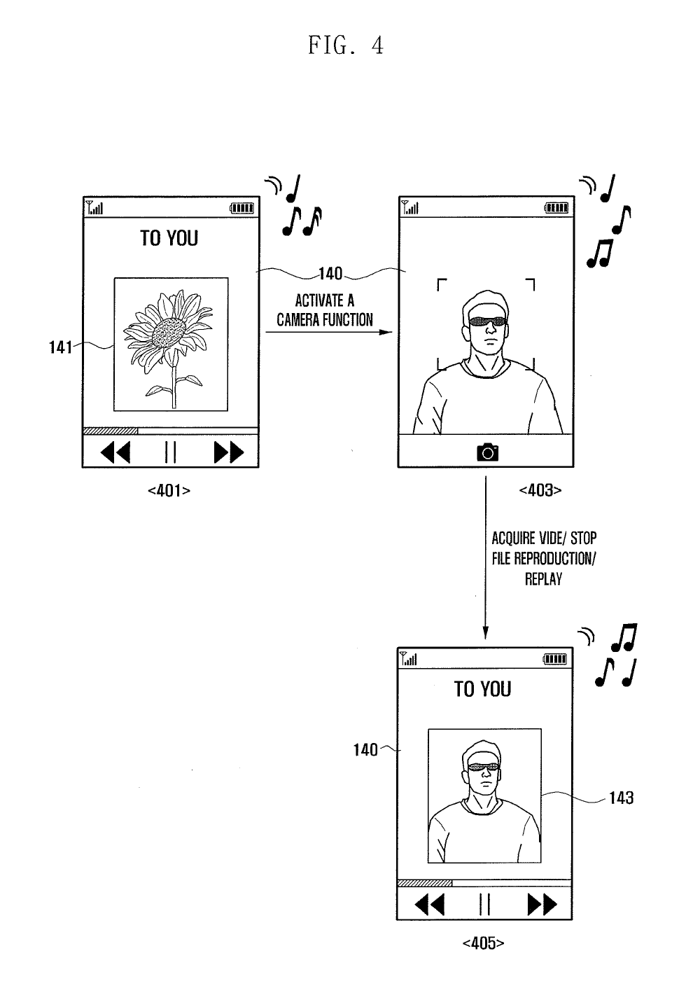

According to the user's settings, the display unit 140 may perform a display operation in such a manner that the default album art image and the album art image created by editing an acquired video are alternatively displayed in a certain period of time; while the default album art image is being displayed, a newly included representative image or album art image is displayed for only a certain time period; or only a newly included representative image or album art image is displayed. The display unit 140 may also display a video newly included in the audio file 151 in a sliding mode or a multi-image output mode. The processes of combining videos with files and displaying the combined representative image or album art image described below with respect to FIGS. 4 to 6.

The storage unit 150 stores programs required for the operations of the mobile device 100. The storage unit 150 also stores data received via the input unit 120, data transmitted from the other mobile devices, videos acquired via the camera 170, etc. The storage unit 150 may include a program storage area and a data storage area.

The program storage area stores an Operating System (OS) for controlling operations of the mobile device 100, applications required to reproduce multimedia content, etc. The program storage area stores a video edit program 153 for supporting the file synthesis and an audio file reproduction program.

The video edit program 153 operates the camera during the reproduction of an audio file, and includes the acquired video in the audio file that is being reproduced, as a representative image or album art image. The video edit program 153 includes a routine for enabling the camera 170 according to an input signal during the reproduction of an audio file; a routine for acquiring videos via the enabled camera 170 according to an input signal; and a video edit routine for including the acquired video in the audio file that is being reproduced, as a representative image or album art image.

The video edit routine may include a number of subroutines. The video edit routine may include a subroutine for determining whether a currently reproduced audio file is terminated; for determining whether a video has been acquired via the camera 170 when the reproduction of an audio file is terminated; and for, if there is a video acquired via the camera 170, including the acquired video in an audio file, as a representative image or album art image, when the reproduction of the video is terminated. The video edit routine may also include a subroutine for extracting a file standard regarding a representative image or album art image of an audio file in order to store the video, acquired via the camera 170, as the representative image or album art image of the audio file. An example of the file standard is an ID3 tag. The video edit routine may further include a subroutine for resizing the acquired video referring to the extracted file standard. If there are a number of videos acquired via the camera, the video edit routine may further include a subroutine for transforming the videos into multi-images, and a subroutine for transforming the images into slide images. The video edit routine may further include a subroutine for including video acquisition information, i.e., location and time when a video is acquired, in a representative image or album art image created when the video is edited.

The audio file reproduction program reproduces an audio file 151 stored in the storage unit 150. The audio file reproduction program includes a routine for outputting a list of audio files stored in the storage unit 150; a routine for reproducing an audio file that is selected from the list via the input unit 120; and a video output routine for identifying a representative image or album art image included in the audio file during the audio file reproduction and displaying it on the display unit 140.

If a representative image or album art image included in an audio file is a single image, the video output routine may include a subroutine for outputting the image on the display unit 140 until the reproduction of the audio file is terminated. If there are a number of representative images or album art images, the video output routine may also include a subroutine for outputting the images on the display unit 140 by adjusting their output times according to the acquisition features of the respective images.

The data storage area stores data created when the mobile device 100 is used, for example, phonebook data, audio data, contents, and information regarding user data. The data storage area may store audio files. i.e., audio files 151, and videos acquired via the camera 170. The data storage area may store audio files that include videos acquired via the camera 170. The audio files combined with videos may be reproduced as typical audio files are reproduced. When typical audio files are reproduced, a default album art image may be output based on information contained in the audio file. When audio files combined with videos are reproduced, newly included images are output as representative images or album art images.

The camera 170 takes a video of a subject. The camera 170 is enabled and acquires a video, according to signals created via the input unit 120 or the display unit 140. The camera 170 includes a camera sensor, an image signal processor, a digital signal processor, etc. The camera sensor converts optical signal to electrical signals. The image signal processor converts analog video signals to digital video signals. The digital signal processor processes the video signals output from the image signal processor, for example, scaling, removing noise, RGB signal transforming, etc., and displays the processed signals on the display unit 140. The camera 170 may be implemented with a Charge-Coupled Device (CCD) sensor or a Complementary Metal-Oxide Semiconductor (CMOS) sensor. The digital signal processor may be omitted in the camera 170.

The camera 170 may support an edit function cooperating with the reproduction of an audio file of the mobile device 100, while the camera 170 is being enabled. The camera 170 may support an image processing function of the digital signal processor, according to the control of a video edit program 153. Examples of the video processing function of the digital signal processor include resizing a video, acquired via the camera 170, to a size as that of a representative image or album art image of an audio file; editing the sizes of a number of acquired videos to those of multi-images that can include a representative image or album art image of an audio file; and editing a number of acquired videos to a slide image to be applied to a representative image or album art image of an audio file.

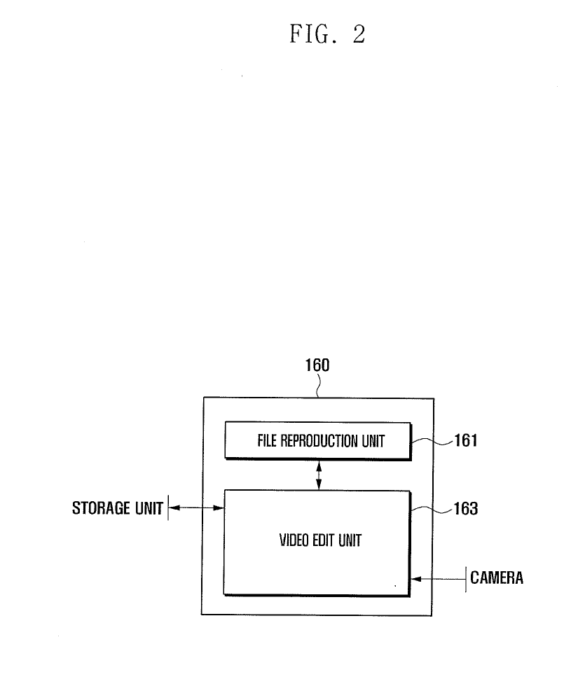

The controller 160 controls operations of the mobile device 100, the signal flows among the components in the mobile device 100, and processes data. The controller 160 may control the reproduction of an audio file, and edit a video acquired via the camera 170, in conjunction with the reproduction of the audio file, during the audio file reproduction. The controller 160 is described below with respect to FIG. 2.

FIG. 2 illustrates a detailed view of the controller 160 of the mobile device shown in FIG. 1 according to an exemplary embodiment of the present invention.

The controller 160 includes a file reproduction unit 161 and a video edit unit 163.

The file reproduction unit 161 controls the reproduction of an audio file stored in the storage unit 150, for example, an audio file 151, when the controller 160 executes an audio file reproduction program stored in the storage unit 150. When the mobile device 100 includes a full touch screen, the file reproduction unit 161 controls the display unit 140 to display a list of audio files stored in the storage unit 150, according to a touch event, or to display a music player interface. The file reproduction unit 161 checks the header of an audio file selected according to a user's control and controls the audio processing unit 130 to reproduce the selected audio file and to output audio signals. The file reproduction unit 161 may control the display unit 140 to display a representative image or album art image included in, or indicated by, the audio file.

When the representative image or album art image included in the audio file is a representative image or album art image of a file combined with a video, the file reproduction unit 161 controls the display unit 140 to display the representative image or album art image of a combined file. When the representative image or album art image of a combined file is created by combining with a number of videos, or multi-images, the file reproduction unit 161 controls the display unit 140 to display the multi-images in a whole screen image or a background image. When the representative image of a combined file is created by combining with a number of videos, or slide images, the file reproduction unit 161 controls the display unit 140 to display a number of representative images, combined with videos, in a slide mode. The file reproduction unit 161 synchronizes a number of representative images edited via videos with particular frames of an audio file and displays them in a slide mode when the audio file is reproduced.

When the file includes location information and time information regarding the representative image or album art image combined with videos, the file reproduction unit 161 controls the display unit 140 to display the information. The file reproduction unit 161 may control the display unit 140 to display the representative image or album art image combined with videos, according to the time information. While displaying an album art image of an audio file, the file reproduction unit 161 controls the display unit 140 to display a representative image or album art image, combined with videos, at a time point where a frame of the audio file is reproduced according to the time information, for a certain period of time.

The video edit unit 163 controls the digital signal processor of the camera 170. The video edit unit 163 edits and stores videos. For example, the video edit unit 163 edits a video acquired via the camera 170 in a particular standard for an audio file, for example, an ID3 tag, and includes the edited video in the audio file. When the camera 170 is enabled to perform a video acquisition function during the reproduction of an audio file, the video edit unit 163 detects size information regarding the representative image or album art image of the ID3 tag of the currently reproduced audio file and edits the acquired video to comply with the detected size. When the camera 170 acquires a number of videos while one audio file is being reproduced, the video edit unit 163 stores the acquired videos in a buffer until the reproduction of the audio file is terminated. When the reproduction of the audio file is terminated, the video edit unit 163 transforms the videos acquired during the audio file reproduction to multi-images, complying with the storage standard of the ID3 tag, or to slide images. In order to transform the videos to slide images, the video edit unit 163 sets time information, i.e., synchronizes respective images with particular audio frames. When a number of videos are acquired while one audio file is reproduced, the video edit unit 163 may display a message asking the user to determine whether the user would like to include the videos in the audio file as multi-images or slide images.

When a single image is acquired during the audio file reproduction or a number of acquired videos are combined with the audio file as multi-images, the video edit unit 163 may also include time information regarding corresponding images in the file. An example of the time information is time information regarding the reproduction of a particular frame in an audio file. When a particular frame in an audio file is reproduced, the video edit unit 163 displays a representative image created by editing a corresponding video.

In order to support a multi-play function, the file synthesis function according to an exemplary embodiment of the present invention may be executed as a particular mode is selected. In order to automatically include a video acquired via the camera 170 in an audio file that is being reproduced, the user can create an input signal to execute the file synthesis mode. When the controller 160 receives a video acquired via the camera 170 in a file synthesis mode during the audio file reproduction, the controller 160 edits the acquired video and includes the edited video in the audio file as a representative image or album art image. The controller 160 may also receive videos acquired via the camera 170 during the reproduction of an audio file when the file synthesis mode is disenabled. In that case, the controller 160 may store the acquired videos in the storage unit 150.

As described above, the mobile device 100 may provide the file synthesis function, edit video acquired via the camera 170 during the reproduction of an audio file, and include the edited videos in the audio file. When the mobile device 100 reproduces the audio file combined with the edited video, the mobile device 100 may output the audio sound and the representative image or album art image of the audio file.

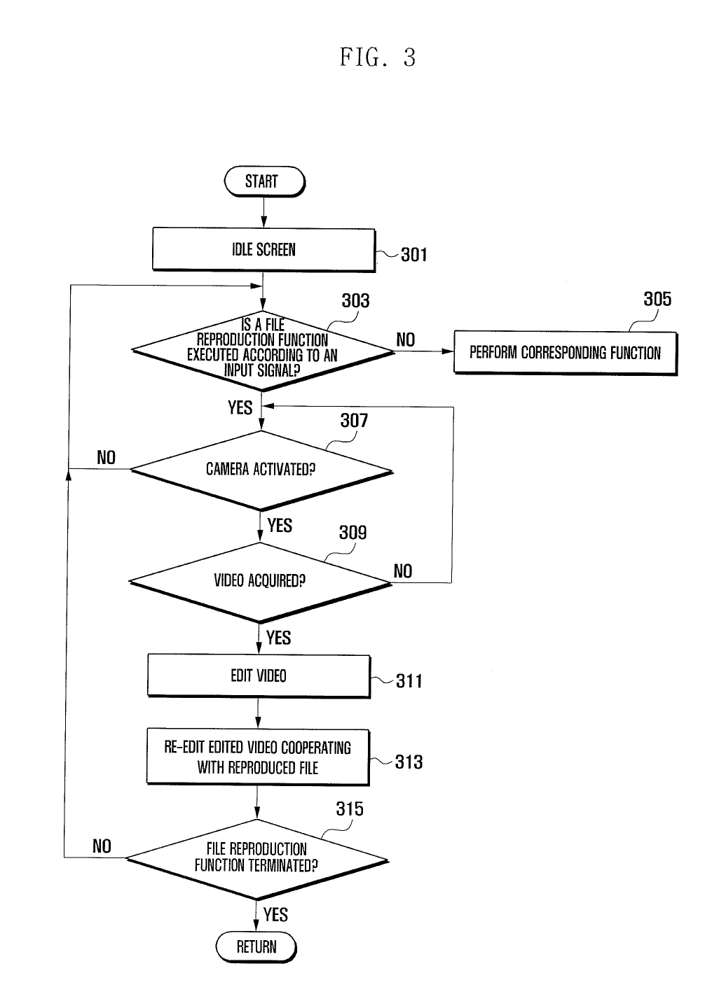

FIG. 3 illustrates a flowchart that describes a method for combining files, according to an exemplary embodiment of the present invention.

Referring to FIG. 3, when the mobile device 100 is turned on, the controller 160 initializes the components. After completing the initialization, the controller 160 controls the display unit 140 to display an idle screen according to a preset schedule in step 301.

The controller 160 determines whether the user input a signal for executing a file reproduction function in step 303. When the controller 160 ascertains that the user does not input a signal for executing a file reproduction function at step 303, the controller 160 performs a function corresponding to a user's input signal in step 305. For example, the controller 160 may execute corresponding functions such as file searching, web accessing, calling, broadcast receiving, etc., output screens according to the execution of functions on the display unit 140, or output audio signals via the audio processing unit 130.

When the controller 160 determines that the user inputs a signal for executing a file reproduction function in step 303, the controller 160 enables a player for reproducing files, and controls the player to reproduce a preset file or a user's selected file. The controller 160 may control the audio processing unit 130 to reproduce a corresponding audio file and output the audio signals. During the file reproduction, the controller 160 determines whether the camera 170 is enabled in step 307. When the controller 160 ascertains that a signal is not input to enable the camera 170 at step 307, the control 160 returns to step 303.

When the controller 160 ascertains that a signal is input to enable the camera 170 in step 307, the controller 160 enables the camera 170 according to the input signal. The controller 160 executes the camera application program and initializes the camera 170. During this process, the controller 160 may control the display unit 140 to display a preview image acquired via the camera 170.

The controller 160 determines whether a signal is input to acquire a video in step 309. When the controller 160 determines that a signal for acquiring a video, for example, a shutter key operation signal, is not input in step 309, the controller 160 returns to step 307.

When the controller 160 determines that a signal for acquiring a video is input at step 309, the controller 160 edits the acquired video in step 311. In order to edit the acquired video, the controller 160 identifies the standard of an image to be added to the currently reproduced audio file, and adjusts the size of the acquired video to comply with the standard. When a number of videos are acquired during the file reproduction, the controller 160 edits the videos to create multi-images or slide images, complying with the standard. The controller 160 may also include reproduction time information regarding fames in created images in the file. The frame reproduction time information may be the order of frames output at time points where videos are acquired.

The controller 160 combines the edited video with the audio file that has been reproduced in step 313. Combining the edited video with an audio file that is being reproduced may be performed when the currently reproduced audio file has been reproduced. The controller 160 includes the edited video in the file as a representative image or album art image. The file reproduction player may automatically select and reproduce another file in the reproduction list. When the camera 170 acquires a video during the reproduction of the other file, the controller 160 may also process the synthesis of the video with the other file in the same way described above.

The controller 160 determines whether an event occurs that terminates the file reproduction in step 315. When the controller 160 determines that such an event does not occur in step 315, the controller 160 returns to step 303. When the controller 160 determines that an event for terminating the file reproduction occurs or the file reproduction is automatically terminated according to a preset schedule in step 315, the controller 160 returns to step 301 and displays an idle screen.

According to another exemplary embodiment of the present invention, enabling the camera 170 in step 307 may further include a step where the controller 160 determines whether to set a file combining mode. When the controller 160 determines that a file combining mode has been set, the controller 160 performs step 309. When the controller 160 determines that a file combining mode is not set, the controller 160 executes a video acquisition function via a multi-play function.

As described above, the file synthesis function providing method reproduces a file via the mobile device 100 and automatically combines a video acquired via the camera 170 with the reproduced audio file. Accordingly, while listing to audio sound according to the reproduction of an audio file, the user can automatically combine a video with the audio file by only controlling the camera 170 to acquire the video.

The screen interface related to the file synthesis function, supported by the mobile device 100 described above, is described below with respect to FIGS. 4 to 6.

FIG. 4 illustrates screens where a file synthesis function is operated in a mobile device, according to an exemplary embodiment of the present invention. In FIG. 4, it is assumed that the mobile device 100 has been set in a file synthesis mode in order to support a file synthesis function.

When the user creates an input signal for selecting and reproducing an audio file, the mobile device 100 reproduces the user's selected file and outputs the audio signal via the audio processing unit 130 as shown in diagram 401. The mobile device 100 also displays a default album art image 141 included the selected audio file on the display unit 140. As shown in diagram 401, the mobile device 100 displays a title of the audio file, for example “TO YOU,” on one side of the screen as well as a key map for controlling the reproduction of the audio file.

When the user creates an input signal for enabling the camera 170 during the audio file reproduction, the mobile device 100 initializes the camera 170 and controls the camera 170 to acquire a video. As shown in diagram 403, the mobile device 100 controls the display unit 140 to display a preview video acquired via the camera 170. During this process, the mobile device 100 continues reproducing the audio file that is being reproduced at the previous step shown in diagram 401, and simultaneously outputs the audio signal via the audio processing unit 130.

As shown in diagram 403, when the camera 170 acquires a video of a particular subject according to the user's input signal, the mobile device 100 is in a standby state until the audio file has been reproduced and then includes the acquired video in the audio file. In order to include the acquired video in a particular area of the audio file, e.g., an ID3 tag, the mobile device 100 acquires an image standard for the ID3 tag, and then resizes the acquired video to comply with the image standard. The mobile device 100 includes the resized video in the ID3 tag of the audio file, as a representative image or album art image.

When the user creates an input signal for replaying the audio file including the edited video, the mobile device 100 controls the audio processing unit 130 to reproduce the audio file and to output the audio signal, and also controls the display unit 140 to display an edited image 143 serving as a representative image or album art image, as shown in diagram 405. The mobile device 100 may adjust a time point to display the edited image 143 on the display unit 140. While the mobile device 100 is displaying the default album art image 141 based on the audio frame time information regarding a time point when the edited image 143 is acquired, as shown in diagram 401, the mobile device 100 may display the edited image as a representative image or album art image at a time point when the audio frame is output according to the time information. In addition, the mobile device 100 may alternatively display the default album art image 141 and the edited image, for a certain period of time, irrespective of time information. During this process, the mobile device 100 may display the title of the audio file, a reproduction control key map, a reproduction slide bar, etc. on the display unit 140, according to the control of the controller 160.

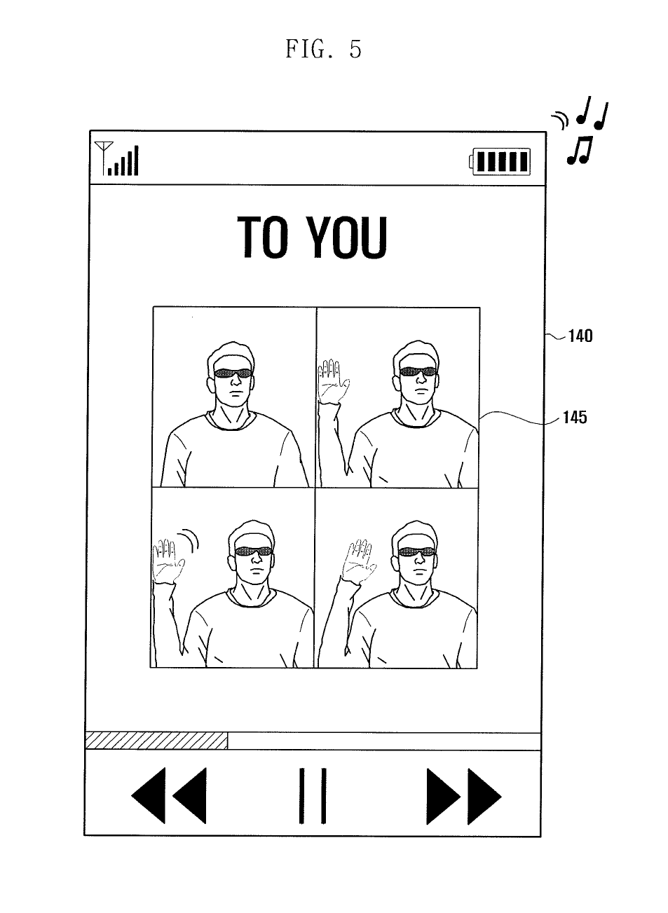

FIG. 5 illustrates a screen to describe a process of editing a video as a representative image or album art image, according to an exemplary embodiment of the present invention.

Referring to FIG. 5, the mobile device 100 may acquire a number of videos via the camera 170, according to a file cooperating edit function described above, during the reproduction of an audio file, according to a user's control. In order to include a number of acquired videos in the currently reproduced audio file as an edit video, the mobile device 100 may create multi-images 145 for the videos, based on a storage standard of the audio file, i.e., ID3 tag standard. When the audio file including the multi-images 145 is reproduced, the mobile device 100 controls the display unit 140 to display the multi-images 145 as a representative image or album art image as shown in FIG. 5.

Like the process of a single image, the mobile device 100 identifies information regarding time that the multi-images 145 are acquired and then adjusts time points to output the multi-images 145. The mobile device 100 may acquire audio frame time information regarding time points where a number of videos are acquired, and display the multi-images 145, at time points where the respective audio frames are output, for a certain period of time. After a certain period of time has elapsed, the mobile device 100 displays the default album art image as shown in diagram 401 of FIG. 4. In addition, the mobile device 100 continues displaying the multi-images 145, from a time point where a corresponding audio frame is output to an audio frame time when the last video is acquired, referring to information regarding an audio frame time when the first video from among the multi-images 145 is acquired. The mobile device 100 may display a default album art image for a period of time where an audio frame is output, other than a corresponding period of time.

Although exemplary embodiments are described in such a manner that the multi-images 145 have the same size, it should be understood that exemplary embodiments of the present invention are not limited thereto. The mobile device 100 may set different weights for multi-images 145 created from a number of videos and adjust areas, in different sizes, to which the multi-images 145 are created and allocated. For example, the mobile device 100 may set, in different sizes, areas of the multi-images 145, so that a video first acquired during the reproduction of an audio file and a video to be combined with an audio file may be allocated to a larger areas than a video acquired after the first acquired video and a video to be included in an audio file. In an environment where the size of an image included in the ID3 tag is limited, the mobile device 100 may adjust the size of respective images to be allocated to the multi-images 145, according to the number of acquired videos. When a number of videos are acquired, the respective videos take relatively smaller areas in the multi-images 145 than those in a case where a relative small number of videos are acquired.

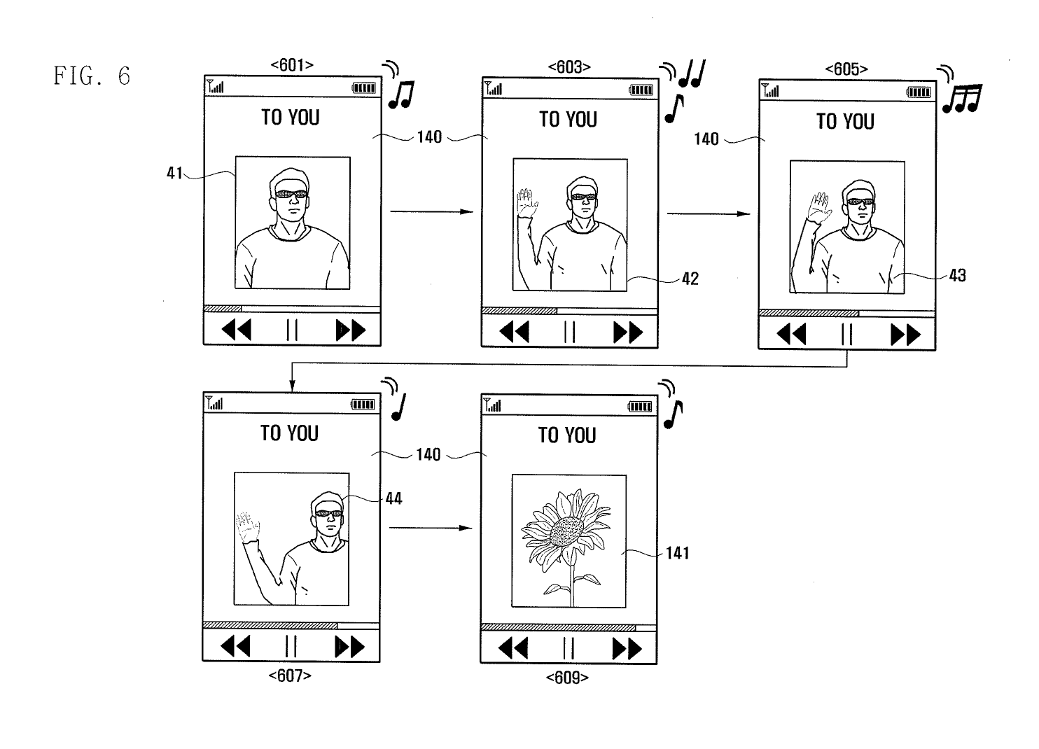

FIG. 6 illustrates screens to describe a process of editing a video as a representative image or album art image, according to another exemplary embodiment of the present invention.

When the mobile device 100 reproduces an audio file including videos edited as slide images, the mobile device 100 may also display screens as shown in FIG. 6. When the mobile device 100 reproduces an audio file including edited videos to be output in a slide mode, according to a user's request, the mobile device 100 outputs the audio signals via the audio processing unit 130. The mobile device 100 may display the first image 41 from the slide images included in the ID3 tag on the display unit 140, as a representative image or album art image, as shown in diagram 601. During this process, the mobile device 100 may also display screen components related to the reproduction of audio file, for example, title of an audio file, a file reproduction control key map, a reproduction slide bar, etc.

After a certain period of time has elapsed, the mobile device 100 removes the first image 41 from the display unit 140 and displays a second image 42 on the display unit 140, as shown in diagram 603. Similarly, the mobile device 100 may display a third image 43 on the display unit 140 as shown in diagram 605, and a fourth image 44 as shown in diagram 607.

When the number of slide images is four and the mobile device 100 displays all the four slide images at a certain time interval, the controller 160 may control the display unit 140 to display a default album art image 141 as shown in diagram 609 of FIG. 9. At a time point when the mobile device 100 displays the slide images, the mobile device 100 may determine time points where respective images included in the slide images are displayed with respect to information regarding an audio frame output time when the slide images are created. For example, an audio file may have a running time of four minutes. The first image 41 may be acquired when one minute of the running time has elapsed, the second image 42 may be acquired when two minutes of the running time has elapsed, a third image 43 may be acquired when three minutes of the running time has elapsed; and a fourth image 44 may be acquired when three minutes and 30 seconds of the running time has elapsed. In that case, the mobile device 100 may create slide images including reproduction time information regarding respective audio frames at time points when videos to be edited for the slide images are created.

When the mobile device 100 displays the slide images on the display unit 140 as a representative image or album art image of the audio file according to the example described above, the mobile device 100 displays the default album art image 141 for one minute. The mobile device 100 then displays the first image 41 for one minute. The mobile device 100 then displays the second image 42 for one minute. The mobile device 100 then displays the third image 43 for 30 seconds, and displays the fourth image 44 for the remaining 30 seconds of the audio file. When a number of videos are acquired and edited to slide images, the mobile device 100 may apply time intervals between the acquired videos to the slide show time intervals of the slide images. The mobile device 100 may also restrict the slide show time of the respective images 41, 42, 43, and 44 to a certain time, and display the default album art image 141 for the remaining period of time.

According to exemplary embodiments of the present invention, when the mobile device 100 includes a video and reproduction time information of a corresponding audio frame in an audio file at a time point where at least one video is acquired, and reproduces the audio file with the acquired video, the mobile device 100 may output one of the acquired video, multi-images, and slide images at a time point when a corresponding audio frame is reproduced according to the audio frame reproduction time information. The mobile device 100 may also display a default album art image, stored in the audio file, for a period of time where one of the acquired video, multi-images, and slide images is not displayed.

The file combining method and the mobile device may display, if the multi-images are displayed during the audio file reproduction, the multi-images for a certain time period, at a time point indicated by audio frame reproduction time information regarding respective acquired images included in the multi-images acquired. Similarly, the file combining method and the mobile device may display, if the multi-images are displayed during the audio file reproduction, the multi-images at a time point indicated by audio frame reproduction time information regarding the first acquired video from among the multi-images, from the time point to a time point where the audio file has been reproduced, or for a certain time period.

The file combining method and the mobile device may display, if the slide images are displayed during the audio file reproduction, respective images included in the slide images, by adjusting the time interval of displaying the respective images according to audio frame reproduction time information regarding when the respective images are acquired. Similarly, the file combining method and the mobile device may also display respective images included in the slide images, by displaying the default album art image, for a certain period of time, between the outputs of respective images.

As described above, the mobile device adapted to the file combining method, according to exemplary embodiments of the present invention, may include at least one edited video, acquired during the reproduction of an audio file, in the audio file as a representative image or album art image. When the mobile device reproduces the audio file including the edited video, the mobile device may control the display unit 140 to display the edited video as a representative image or album art image.

As described above, the file combining method and the mobile device adapted thereto, according to exemplary embodiments of the present invention, allows users to photograph a video via the camera, play back an audio file, automatically combine the video with the audio file, and store the audio file, so that the users can easily edit the file. When the audio file is played back later, the file combining method and the mobile device adapted thereto can remind the user of the situation and environment the time when the video was acquired.

Although not shown, the mobile device may include additional units, such as a short-range communication module for short-range wireless communication; an interface for transmitting/receiving data in a wireless or weird mode; an Internet communication module; and a digital broadcast module for receiving and reproducing broadcast. Other units equivalent to the above-listed units may be further included in the mobile device. The mobile device may be implemented by omitting a particular element or replacing it with other elements.

The mobile device 100 may be any information communication device, multimedia device, and application, which can acquire videos via a camera during an audio file reproduction and are operated according to communication protocols corresponding to a variety of communication systems. For example, the mobile device 100 may be a mobile communication terminal, a Portable Multimedia Player (PMPs), a digital broadcast player, a Personal Digital Assistant (PDAs), an audio players (e.g., MP3 players), a mobile game player, a smartphone, a laptop computer, a handheld Personal Computer (PC), etc.

While the invention has been shown and described with reference to certain exemplary embodiments thereof, it will be understood by those skilled in the art with reference to certain exemplary embodiments thereof the spirit and scope of the present invention as defined by the appended claims and the equivalents.

What is claimed is:

1. A file combining method for providing a file combining function, the method comprising:
reproducing an audio file;
enabling a camera during the audio file reproduction;
acquiring at least one video via the camera during the audio file reproduction; and
combining the acquired at least one video with the currently reproduced audio file.

2. The method of claim 1, wherein the combining of the acquired at least one video with the currently reproduced audio file comprises:
including at least one acquired video in the audio file at a time point when the audio file has been reproduced.

3. The method of claim 1, wherein the combining of the acquired at least one video with the currently reproduced audio file comprises at least one of the following:
including, if one video is acquired, the one video in the audio file as a representative image or album art image;
combining, if a plurality of videos are acquired, the plurality of videos to create multi-images, and including the multi-images in the audio file as a representative image or album art image; and
combining, if the plurality of videos is acquired, the plurality of videos to create slide images, and including the slide images in the audio file as a representative image or album art image.

4. The method of claim 3, further comprising:
resizing at least one of the one video, multi-images, and slide images, in accordance with a storage standard of an image for the audio file.

5. The method of claim 3, further comprising:
reproducing an audio file including the acquired at least one video; and
displaying the acquired at least one video as a representative image or album art image of the audio file during the audio file reproduction.

6. The method of claim 5, wherein the displaying of the acquired at least one video comprises:
displaying one of the one video, multi-images, slide images, and a default album art image included in the audio file, according to a preset order.

7. The method of claim 3, further comprising:
including reproduction time information regarding a corresponding audio frame at a time point when the at least one video is acquired.

8. The method of claim 7, further comprising:
reproducing an audio file including the acquired at least one video; and
displaying one of the one video, multi-images, and slide images at a time point when an audio frame is reproduced according to audio frame reproduction time information.

9. The method of claim 7, further comprising:
displaying a default album art image included in the audio file for a period of time where one of the one video, multi-images, and slide images is not displayed.

10. The method of claim 7, wherein the displaying of the default album art image comprises:
if the multi-images are displayed during the audio file reproduction, displaying the multi-images for a certain time period, at a time point indicated by audio frame reproduction time information regarding respective acquired images included in the multi-images acquired; or
if the multi-images are displayed during the audio file reproduction, displaying the multi-images at a time point indicated by audio frame reproduction time information regarding the first acquired video from among the multi-images, from the time point to a time point where the audio file has been reproduced, or for a certain time period; or
if the slide images are displayed during the audio file reproduction, displaying respective images included in the slide images, by adjusting the time interval of displaying the respective images according to audio frame reproduction time information regarding when the respective images are acquired; or
displaying respective images included in the slide images, by displaying the default album art image for a certain period of time, between the output of respective images.

11. A mobile device for providing a file combining function, the device comprising:
an audio processing unit for outputting audio signals when an audio file is reproduced;
a camera for acquiring at least one video during the audio file reproduction; and
a controller for enabling the camera to acquire the at least one video during the audio file reproduction and for including the acquired at least one video in the currently reproduced audio file.

12. The mobile device of claim 11, wherein the controller comprises:
a file reproduction unit for reproducing the audio file; and
a video edit unit for including the acquired at least one video in the audio file at a time point when the audio file has been reproduced.

13. The mobile device of claim 11, wherein:
the controller comprises a video edit unit;
wherein, if one video is acquired, the video edit unit includes the one video in the audio file as a representative image or album art image,
wherein, if a plurality of videos is acquired, the video edit unit combines the videos to create multi-images, and includes the multi-images in the audio file as a representative image or album art image, and
wherein, if the plurality of videos is acquired, the video edit unit combines the videos to create slide images, and includes the slide images in the audio file as a representative image or album art image.

14. The mobile device of claim 13, wherein the video edit unit resizes at least one of the one video, multi-images, and slide images, complying with the storage standard of an image for the audio file.

15. The mobile device of claim 13, wherein:
the controller comprises a file reproduction unit, and
wherein the file reproduction unit displays the acquired at least one video as a representative image or album art image of the audio file during the audio file reproduction.

16. The mobile device of claim 15, wherein the file reproduction unit displays one of the one video, multi-images, slide images, and a default album art image included in the audio file, according to a preset order.

17. The mobile device of claim 13, wherein the video edit unit includes reproduction time information regarding a corresponding audio frame at a time point that the at least one video is acquired.

18. The mobile device of claim 17, wherein:
the controller comprises a file reproduction unit, and
wherein the file reproduction unit displays one of the one video, multi-images, and slide images at a time point when an audio frame is reproduced according to audio frame reproduction time information.

19. The mobile device of claim 17, wherein:
the controller comprises a file reproduction unit, and
wherein the file reproduction unit displays a default album art image included in the audio file for a period of time where one of the one video, multi-images and slide images is not displayed.

20. The mobile device of claim 17, wherein:
the controller comprises a file reproduction unit, and
wherein, if the multi-images are displayed during the audio file reproduction, the file reproduction unit displays the multi-images for a certain time period, at a time point indicated by audio frame reproduction time information regarding respective acquired images included in the multi-images acquired, or
wherein, if the multi-images are displayed during the audio file reproduction, the file reproduction unit displays the multi-images at a time point indicated by audio frame reproduction time information regarding the first acquired video from among the multi-images describes, from the time point to a time point where the audio file has been reproduced, or for a certain time period, or
wherein, if the slide images are displayed during the audio file reproduction, the file reproduction unit displays respective images included in the slide images, by adjusting the time interval of displaying the respective images according to audio frame reproduction time information regarding when the respective images are acquired, or
wherein the file reproduction unit displays respective images included in the slide images, by displaying the default album art image for a certain period of time, between the outputs of respective images.
